(19) United States
(12) Patent Application Publication
(10) Pub. No.: US 2007/0211490 A1
(43) Pub. Date: Sep. 13, 2007

(54) Light-emitting diode backlight module of a display

(76) Inventor: Hsien-Chung Chou, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/438,427

(22) Filed: May 23, 2006

(30) Foreign Application Priority Data
Mar. 13, 2006 (TW) 095204088

(51) Int. Cl. F21V 7/04

(52) U.S. Cl. 362/555

(57) ABSTRACT

A light-emitting diode backlight module of a display, including a mother circuit board, multiple light-emitting diode units arranged on the mother circuit board and a cover board formed with multiple receiving cavities on a first face. The receiving cavities are respectively aligned with the light-emitting diode units arranged on the mother circuit board, whereby the light-emitting diode units are accommodated in the receiving cavities. The first face of the cover board is attached to the mother circuit board to form a plane flat light-emitting diode backlight module. The cover board is a light guide board or a board body made from a heat-radiating material.

### BACKGROUND OF THE INVENTION

1. Field Of The Invention

The present invention is related to a light-emitting diode LED ) backlight module of a display. The light-emitting diode backlight module includes a mother circuit board and multiple light-emitting diode units laid out on the mother circuit board. The light-emitting diode units, the mother circuit board and a cover board are packaged to form a plane integrated light-emitting diode backlight module.

2. Description of the Prior Art

FIG. 7 shows an existent direct type backlight module applied to a liquid crystal display. The direct type backlight module includes a light cabinet 51 which is a trapezoid body with a wider upper side and a narrower lower side. Multiple light-emitting cells 52 such as CCFL or light-emitting diodes are arranged in the light cabinet 51. A scattering board 53 is overlaid on the top end of the light cabinet 51. The scattering board 53 serves to evenly scatter the light emitted from the light-emitting cells 52 to a glass layer 54 of the display.

In the above direct type backlight module, the light-emitting cells 52 are arranged in the trapezoid light cabinet 51. The light emitted from the light-emitting cells 52 is guided by the trapezoid light cabinet 51 toward the scattering board 53. Such light cabinet 51 has a considerably large volume and heavy weight. This fails to meet the requirements for lightweight and thin liquid crystal display.

### SUMMARY OF THE INVENTION

It is therefore a primary object of the present invention to provide a light-emitting diode backlight module of a display, including: a mother circuit board; multiple light-emitting diode units arranged on the mother circuit board; and a cover board formed with multiple receiving cavities on a first face. The receiving cavities are respectively aligned with the light-emitting diode units arranged on the mother circuit board, whereby the light-emitting diode units are accommodated in the receiving cavities. The first face of the cover board is attached to the mother circuit board. The light-emitting diode units, the mother circuit board and the cover board are packaged to form a plane integrated light-emitting diode backlight module.

It is a further object of the present invention to provide the above light-emitting diode backlight module in which the cover board is a light guide board for outwardly guiding the light emitted from the light-emitting diode units.

It is still a further object of the present invention to provide the above light-emitting diode backlight module in which the cover board is made from a heat-radiating material and formed with multiple receiving through holes. The light-emitting diode units arranged on the mother circuit board are respectively accommodated in the receiving through holes. The light-emitting' diode units, the mother circuit board and the cover board' are packaged to form an integrated module installable on one side of a light guide board and a scattering board.

The present invention can be best understood through the following description and accompanying drawings wherein:

### BRIEF DESCRIPTION OF THE DRAWINGS

FIG. 1 is a sectional view of the light-emitting diode backlight module of the present invention;

FIG. 2 is a sectional view showing that the light-emitting diode backlight module of the present invention is applied to a liquid crystal display in one aspect;

FIG. 3 is a sectional view of the light-emitting diode backlight module of the present invention, showing that the cover board is enclosed in a reflective frame body;

FIG. 4 shows a layout of the light-emitting diode units arranged on the mother circuit board of the present invention;

FIG. 5 shows another layout of the light-emitting diode units arranged on the mother circuit board of the present invention;

FIG. 6 is a sectional view showing that the light-emitting diode backlight module of the present invention is applied to a liquid crystal display in another aspect; and

FIG. 7 shows a conventional direct type backlight module.

### DETAILED DESCRIPTION OF THE PREFERRED EMBODIMENTS

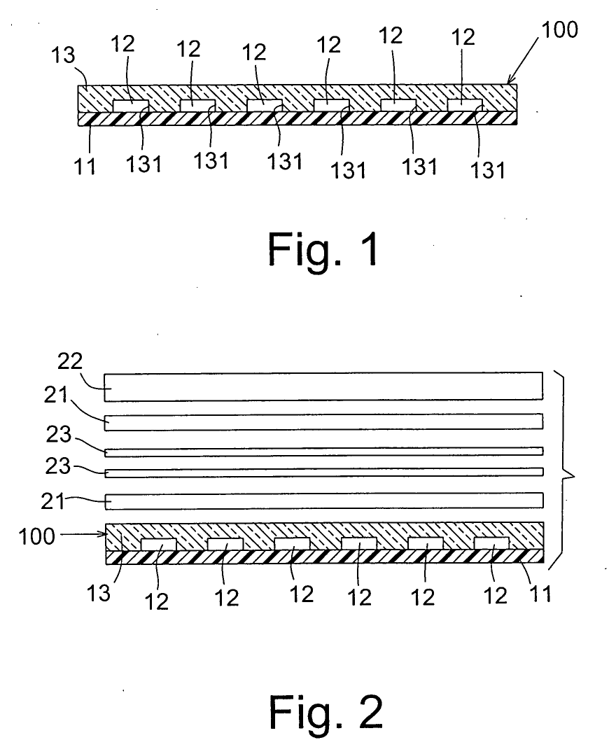

Please refer to FIGS. 1 to 5. The light-emitting diode backlight module 100 of the display of the present invention includes a mother circuit board 11, multiple light-emitting diode units 12 arranged on the mother circuit board 11 and a cover board 13 formed with multiple receiving cavities 131 on a first face. The receiving cavities 131 are respectively aligned with the light-emitting diode units 12 arranged on the mother circuit board 11, whereby the light-emitting diode units 12 are accommodated in the receiving cavities 131. The first face of the cover board 13 is attached to the mother circuit board 11 to form a plane flat light-emitting diode backlight module 100. The cover board 13 can be a transparent light guide board or a board body made from heat-radiating materials.

Referring to FIG. 2, the cover board 13 of the light-emitting diode backlight module 100 is attached to one face of a scattering board 21. The light emitted from the light-emitting diode units 12 goes through the cover board 13 to be evenly scattered by the scattering board 21 to a glass layer 22. Multiple scattering boards 21 can be sandwiched between the cover board 13 and the glass layer 22. Alternatively, a brightening board 23 can be sandwiched between two scattering boards 21.

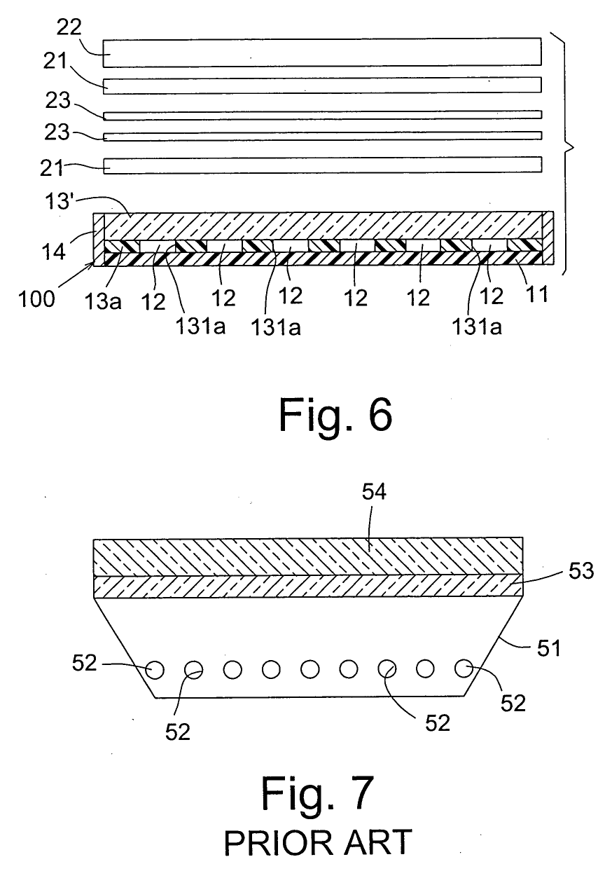

The cover board 13 can be a light guide board made from transparent materials for outwardly guiding the light emitted from the light-emitting diode units 12. Alternatively, as shown in FIG. 6, the cover board 13a can be made from a heat-radiating material and formed with multiple receiving through holes 131 a. The light-emitting diode units 12 arranged on the mother circuit board 11 are respectively accommodated in the receiving through holes 131a. The cover board 13a has a thickness equal to the height of the light-emitting diode units 12 protruding from the mother circuit board 11. Accordingly, when the cover board 13a is attached to the mother circuit board 1 1, the front faces of the light-emitting diode units 12 are flush with the top face of the cover board 13a. Accordingly, the light-emitting diode backlight module 100 of the present invention has a plane configuration. Also, the light can be emitted from the light-emitting diode units 12 without being obstructed by the cover board 13a. The light can be outwardly scattered by large angle to enhance the light-emitting area. The cover board 13a, light-emitting diode units 12 and mother circuit board 11 are packaged into an integrated body. In application, the integrated body can be positioned on one face of the glass layer 22 of the display. In addition, a light guide board 13′ and several scattering boards 21 or brightening boards 23 can be sandwiched between the integrated body and the glass layer 22.

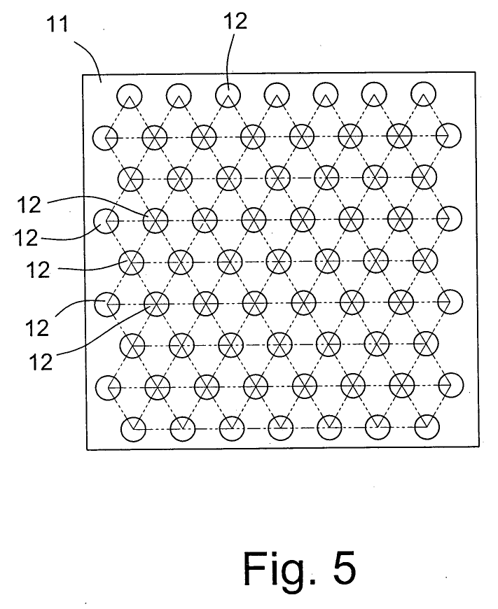

Referring to FIG. 4, in the light-emitting diode backlight module 100 of the present invention, the light-emitting diode units 12 laid on the mother circuit board 11 can be arranged into multiple square arrays outwardly diverging from the center of the mother circuit board 11 (as shown by the phantom lines of FIG. 4). The light-emitting diode units 12 are such laid out that the innermost array is defined as a first array having one single light-emitting diode unit 12. The array immediately surrounding the first array is defined as a second array. The array immediately surrounding the second array is defined as a third array. The array immediately surrounding the third array is defined as a fourth array. The array immediately surrounding the (n−1) array is defined as an nth array. The arrays are squarely arranged at equal intervals. The numbers of the light-emitting diode units 12 of the respective arrays sequentially are 4, 8, 12, 16 . . . 4(n−1), wherein n represents the number of the array and n is a natural number and n≧2. Alternatively, the light-emitting diode units 12 laid on the mother circuit board 11 can be positioned at the tips of multiple equal regular triangles (as shown by phantom lines of FIG. 5 ). The regular triangles share the tips with each other. The arrangement of the light-emitting diode units 12 is not limited.

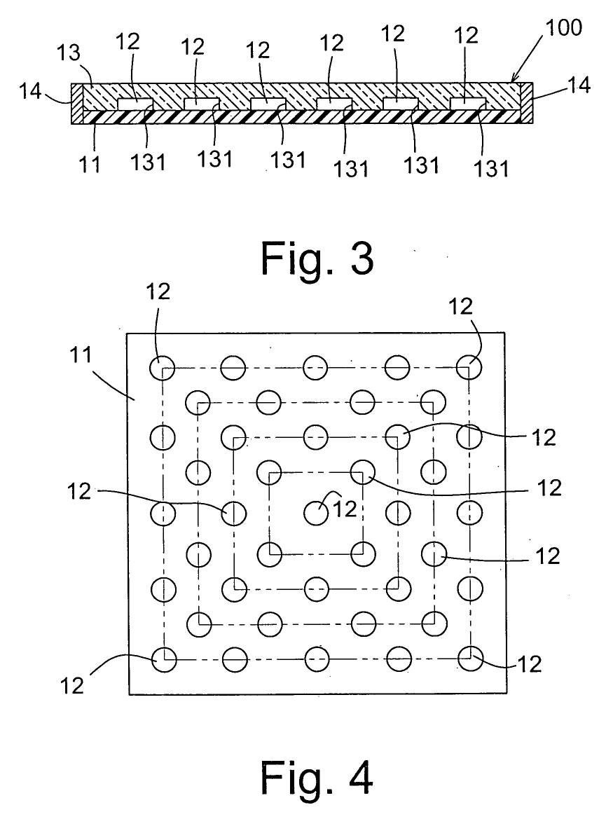

Referring to FIG. 3, the cover board 13 can be further enclosed in a reflective frame body 14 for reflecting the light laterally emitted from the light-emitting diode units 12. Therefore, the light emitted from the light-emitting diode units 12 can be concentrated to go out from the transparent cover board 13 (the light guide board).

In comparison with the conventional direct type backlight module, the light-emitting diode backlight module 100 of the present invention is free from the light shade. Therefore, as a whole, the structure of the present invention is more lightweight, thinner and smaller. The plane flat light-emitting diode backlight module 100 of the present invention can be more easily installed and applied to the liquid crystal display.

The above embodiments are only used to illustrate the present invention, not intended to limit the scope thereof. Many modifications of the above embodiments can be made without departing from the spirit of the present invention.

What is claimed is:

1. A light-emitting diode backlight module of a display, comprising:
(a) a mother circuit board;
(b) multiple light-emitting diode units arranged on the mother circuit board; and
(c) a cover board made from transparent light guide material, the cover board being formed with multiple receiving cavities on a first face, the receiving cavities being respectively aligned with the light-emitting diode units arranged on the mother circuit board, whereby the light-emitting diode units are accommodated in the receiving cavities, the first face of the cover board being attached to the mother circuit board to form a plane flat light-emitting diode backlight module.

2. The light-emitting diode backlight module of the display as claimed in claim 1, wherein the cover board is enclosed in a reflective frame body.

3. The light-emitting diode backlight module of the display as claimed in claim 1, wherein the light-emitting diode units laid on the mother circuit board are arranged into multiple square arrays outwardly diverging from a center of the mother circuit board, the light-emitting diode units being such laid. out that an innermost array is defined as a first array having one single light-emitting diode unit, an array immediately surrounding the first array being defined as a second array, an array immediately surrounding the second array being defined as a third array, an array immediately surrounding the (n−1) array being defined as an nth array, the arrays being squarely arranged at equal intervals, the numbers of the light-emitting diode units of the respective arrays being 4(n−1), wherein n represents the number of the array and n is a natural number and n≧2.

4. The light-emitting diode backlight module of the display as claimed in claim 1, wherein the light-emitting diode units laid on the mother circuit board are positioned at the tips of multiple equal regular triangles, the regular triangles sharing the tips with each other.

5. A light-emitting diode backlight module of a display, comprising:
(a) a mother circuit board;
(b) multiple light-emitting diode units arranged on the mother circuit board; and
(c) a cover board made from transparent light guide material, the cover board being formed with multiple receiving through hole, the light-emitting diode units arranged on the mother circuit board being respectively accommodated in the receiving through holes.

6. The light-emitting diode backlight module of the display as claimed in claim 5, wherein the cover board is attached to one face of a light guide board and the light guide board is enclosed in a reflective frame body.

7. The light-emitting diode backlight module of the display as claimed in claim 5, wherein the cover board has a thickness equal to a height of the light-emitting diode units protruding from the mother circuit board, whereby when the cover board is attached to the mother circuit board, front faces of the light-emitting diode units are flush with a top face of the cover board.

8. The light-emitting diode backlight module of the display as claimed in claim 5, wherein the cover board is made from a heat-radiating material.

9. The light-emitting diode backlight module of the display as claimed in claim 5, wherein the light-emitting diode units laid on the mother circuit board are arranged into multiple square arrays outwardly diverging from a center of the mother circuit board, the light-emitting diode units being such laid out that an innermost array is defined as a first array having one single light-emitting diode unit, an array immediately surrounding the first array being defined as a second array, an array immediately surrounding the second array being defined as a third array, an array immediately surrounding the (n−1) array being defined as an nth array, the arrays being squarely arranged at equal intervals, the numbers of the light-emitting diode units of the respective arrays being 4(n−1), wherein n represents the number of the array and n is a natural number and n≧2.

10. The light-emitting diode backlight module of the display as claimed in claim 5, wherein the light-emitting diode units laid on the mother circuit board are positioned at the tips of multiple equal regular triangles, the regular triangles sharing the tips with each other.
